(19) United States
(12) Patent Application Publication
(10) Pub. No.: US 2007/0220577 A1
(43) Pub. Date: Sep. 20, 2007

(54) Method and media manager client unit for optimising network resources usage

(76) Inventor: George Philip Kongalath, Saint-Laurent (CA)

Correspondence Address: Alex Nicolaescu;Ericsson Canada Inc., Patent Department, 8400 Decarie Blvd., Town Mount Royal, QC, H4P 2N2, CA

(21) Appl. No.: 11/375,220

(22) Filed: Mar. 15, 2006

(51) Int. Cl. H04N 7/16; H04N 7/173

(52) U.S. Cl. 725/131; 725/151; 725/139; 725/107

(57) ABSTRACT

A method, system, and media manager client unit are provided for controlling the transmission of a multimedia content from a content provider server to the media manager client unit. When the later receives an indication from a cooperating entity that the multimedia content is no longer used, it issues a request for the server to end the transmission of the multimedia content, thus freeing up bandwidth resources used for the transmission. Alternatively, the request can be sent also to a bandwidth manager that manages the bandwidth resources of the system. The cooperating entity sending the indication can be, for example, a media consumer such as a TV set or a display, that is turned off, or an Operating System (OS) detecting either another active application than the multimedia application responsible for rendering the multimedia content or a period of no activity by the user of the multimedia application.

### TECHNICAL FIELD

The present invention relates to a method and Media Manager Client Unit for optimising network resources used for media streaming.

### BACKGROUND

With the advent of broadband transmission technology, it has become possible to digitize multimedia content, such as TV (television) content, and to transmit such content via broadband networks. IP (Internet Protocol) TV is a method of distributing TV content over IP that enables a more customized and interactive user experience. IPTV uses a two-way broadcast signal sent through a service provider's backbone network and servers, allowing viewers to select content on demand, timeshift, and take advantage of other interactive TV options. The viewer must have a broadband connection and a so-called Set-Top Box (STB) to be able to send and receive requests. Traditional cable digital television has the capacity to deliver channels simultaneously to each subscriber. IPTV, by contrast, sends one program at a time to each user. When a viewer changes the channel or selects another program, a new stream of content is transmitted from the provider's server directly to the viewer's STB. IPTV primarily uses multicasting with, for example, Internet Group Management Protocol (IGMP) version 2 for live television broadcasts and Real Time Streaming Protocol for on-demand programs. Compatible video compression standards used for IPTV transmissions include H.264, Windows Media Video 9 and VC1, DivX, XviD, and the MPEG-2 and -4 (Moving Picture Experts Group).

In applications like IPTV, the user terminal receives the TV multimedia content via the STB, which is an electronic device that enables a television set to become a user interface to the Internet. An STB decodes broadcast signals thus enabling the TV set to receive and display content programs. An STB is necessary to television viewers who wish to use their current analog television sets to receive digital broadcasts. On the other hand, newer digital TVs have the decoding functions of the STB already included therein. Digital STB are used for satellite, cable, and terrestrial DTV (digital TV) services.

An STB can also be viewed as a specialized computer that can communicate with the Internet—that is, it contains a Web and supports the Internet's main program, TCP/IP (Transfer Control protocol/Internet Protocol). The service to which the STB is attached may be through a telephone line as, for example, with Internet-based TV service, or through a cable TV company as it is well known in the art.

In the DTV realm, a typical digital STB contains one or more microprocessors for running an operating system (OS), and for parsing the MPEG transport stream received from the content provider. An STB may also include RAM, an MPEG decoder, as well as audio decoders and processors. More sophisticated STBs may also contain a hard drive for storing recorded DTV broadcasts, downloaded software, or other applications provided by the DTV service provider.

However, with all types of existing STBs, the transmitted digital content typically contains both sound and video signals, thus requiring a considerable bandwidth to be reserved for each working STB in the network. When a viewer selects to watch a DTV channel, a bandwidth reservation typically takes place in the network between the content provider server and the viewer's STB for insuring the proper and uninterrupted transmission of the digital content of the selected channel to the viewer's STB. However, if at a given moment during the program the user decides not to watch TV any longer, and for example turns off the TV, but not the STB, the digital content continues to be transmitted over the reserved bandwidth to the viewer's STB. This amounts to a waste of bandwidth, since the viewer is no longer watching TV.

Reference is now made to FIG. 1 (Prior Art), which is a high level network diagram of a prior art implementation of a cable-based TV transmission toward a viewer's STB and TV set. Shown in FIG. 1 is a cable network 100 implemented for the transmission of DTV content to TV viewers. The cable network 100 comprises at least one service provider server 102 containing a live TV transmission module 104, which is responsible for receiving from various television stations or other content providers live TV content 105, such as for example sports matches, TV shows and the like, and for its transmission over the cable distribution network 108 towards viewer's premises. The content provider 102 also comprises a stored content module 106, with stores television content for transmission over the same distribution network 108 toward the viewer's premises. The live or stored television content 114 is thus transmitted over the cable distribution network 108 up to viewer's STBs, such as for example to the STB 110, which is located in a viewer's house. The STB 110 typically acts to decode the DTV or IPTV signals 114 and possibly also to convert the decoded signals into an analog television signal 116 to be transmitted to the TV set 112. Typically, the bandwidth reservation takes place between the content provider 102 and the STB 110 for insuring the proper and uninterrupted transmission of the digital signal 114. Thus, when the viewer watches television, a portion of the network 108 bandwidth is reserved for the transmission of the digital signal 114 to the STB 110. In the case of IPTV, when the viewer changes the channel, the STB processes the viewer's action typically performed via a remote control of the STB, and sends a channel change message 115 back to the content provider 102, the message informing the content provider server 102 to stop transmitting the former channel content, and to begin the transmission of the new channel content. Likewise, if the viewer interrupts in action 118 the transmission of a program, such as a movie being streamed to the STB 110, or simply powers off the STB, a message 117 is transmitted from the STB 110 to the content provider server 102 in order to request the later to stop the program's transmission towards the STB 110, and to free up the corresponding reserved bandwidth.

However, instances arise when the viewer, instead of powering off the STB rather uses controls associated with the TV set 112 in order to either power off the TV set or to select a different source of TV content to be played on the TV 112, such as for example a satellite receiver (not shown in FIG. 1), instead of the STB 110. In such as circumstance, because the interface between the STB 110 and the TV set 112 is unidirectional, i.e. configured to only send signals from the STB 110 towards the TV 112, the STB 110 is not notified of the fact that the TV set 112 no longer uses the content signal 116 fro the STB 110. As a consequence, the digital signal 114 continues to be sent over the reserved bandwidth from the content provider server 102 to the STB 110, which unnecessarily uses the resources of the distribution network 108.

A similar situation also occurs in cellular networks. Reference is now made to FIG. 2 (Prior Art), which is another high-level network diagram of a prior art implementation of a cellular network-based multimedia content distribution towards a Mobile Station (MS). Shown in FIG. 2 is a cellular network 200 that comprises a content provider server 202 adapted to send television (e.g. IPTV) or other multimedia content to cellular network users. For this purpose, the content provides server 202 comprises a live television module 204, which receives live television content 205 from various sources and further streams that content towards MSs of the network 200. The content provider server 202 also contains a stored TV and/or multimedia content module 206, which stores various TV programs, or other multimedia content, for streaming towards MSs of the network 200. The content providers server 202 is in communication with the core network 208 (e.g. comprising digital switching nodes and routers) of the cellular network 200, which in turns connects to a Radio Access Network 209 (RAN, e.g. comprising radio network controllers and base stations). The RAN 209 provides cellular radio coverage and service to a number of MSs alike the illustrated MS 211. The later comprises a multimedia and/or TV rendering application 210 capable of decoding the multimedia and/or TV signal received from the content provider server 202, and for converting it into a signal ready to be played on the MS's output user interface 212 that may comprise, for example, the MS's display and speaker. When the digital television or other multimedia content 214 is streamed from the content provider server 202 via the core network 208 and the RAN 209 up to the MS 211, the multimedia rendering application 210 acts analogously to the previously described STB and decodes, and runs, the decoded TV or multimedia signal on the user interface 212. For this purpose, in a manner analogous to the one described in relation to FIG. 1, a certain amount of bandwidth is reserved for the transmission of the TV or multimedia digital stream 214 between the content provider server 202 and the MS 211. In cellular networks, bandwidth is a critical issue, since the total bandwidth of the radio interface between RAN 209 and served mobile stations is rather limited. Therefore, it is necessary to carefully and efficiently manage bandwidth reservation and assignment in order to provide optimal service to cellular users. However, instances arise where during the streaming of the TV or multimedia digital stream 214 to the MS 211, the MS's user activates and uses another application on the MS than the rendering application 210. For example, while watching a video clip being downloaded from the content provider server 202, the user of the MS 211 launches a game without first terminating the application. In such instances, the streaming of the video clip becomes useless for the user. However, in current implementations, although the streaming of the video clip is useless for the user, the bandwidth between the content provided 202 and a MS 211 continues to be reserved, thus unnecessarily wasting the networks resources.

An analogous issue also exists in the Personal Computers (PC) world. When a PC-based multimedia application connects via an Internet Service Provider (ISP) to an Internet-based multimedia content server for downloading multimedia digital content such as for example a movie's preview in the form of a video clip, bandwidth and server resources may be unduly consumed if the user is occupied with another active application on his/her PC, or is no longer using the PC at all.

The above illustrated problems result in significant bandwidth and resources utilization in circumstances wherein the data stream being downloaded towards the user's equipment is totally unused, and thus wasted.

In today's implementations, the STBs or the PC-implemented or MS-implemented multimedia applications continue to download digital multimedia content streams, even in circumstances where these downloads are unused by the viewer or the user.

### SUMMARY

Accordingly, it should be readily appreciated that in order to overcome the deficiencies and shortcomings of the existing solutions, it would be advantageous to have a solution for effectively managing digital multimedia content, including digital television content, being downloaded to an STB, an MS or a PC, wherein the download of such a content is stopped in circumstances when the viewer no longer uses the downloaded content. The present invention provides such a solution.

In one aspect, the present invention is a method for controlling communications, the method comprising the steps of:

a. receiving at a media manager client from a cooperating entity an indication that a multimedia content being received by the media manager client from a content provider server is not used;

b. responsive to a receipt of the indication from a cooperating entity, creating a message for requesting an end of a transmission of the multimedia content; and

c. sending the message to request the end of the transmission of the multimedia content.

In another aspect, the present invention is a media manager client unit comprising:

an interface which is adapted to receive from a cooperating entity an indication that a multimedia content being received by the media manager client from a content provider server is not used; and

a control unit receiving the indication from the interface, the control unit being configured to create a message for requesting an end of a transmission of the multimedia content responsive to a receipt of the indication, and to send the message to request the end of the transmission of the multimedia content.

In yet another aspect, the present invention is a multimedia distribution system comprising:

a content provider server;

a media manager client connected to the content provider server and receiving from the content provider server a multimedia content; and

a cooperating entity connected to the media manager client, the cooperating entity sending to the media manager client an indication that the multimedia content being received by the media manager client from the content provider server is not used;

the media manager client, upon receipt of the indication, acting to create a message for requesting an end of a transmission of the multimedia content and further acting to send the message to the content provider to request the end of the transmission of the multimedia content.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high level network diagram of a prior art implementation of a cable-based TV or multimedia content transmission toward a viewer's STB and TV set;

FIG. 2 (Prior Art) is another high level network diagram of a prior art implementation of a cellular network-based TV or multimedia content distribution toward a mobile station;

FIG. 3 is an exemplary high-level network diagram of the preferred embodiment of the invention;

FIG. 4 is a nodal operation and signal flow diagram of an exemplary implementation of the preferred embodiment of the invention;

FIG. 5 is a nodal operation and signal flow diagram of other exemplary implementations of the preferred embodiment of the invention; and

FIG. 6 is a high level block diagram of an exemplary implementation of the preferred embodiment of the invention.

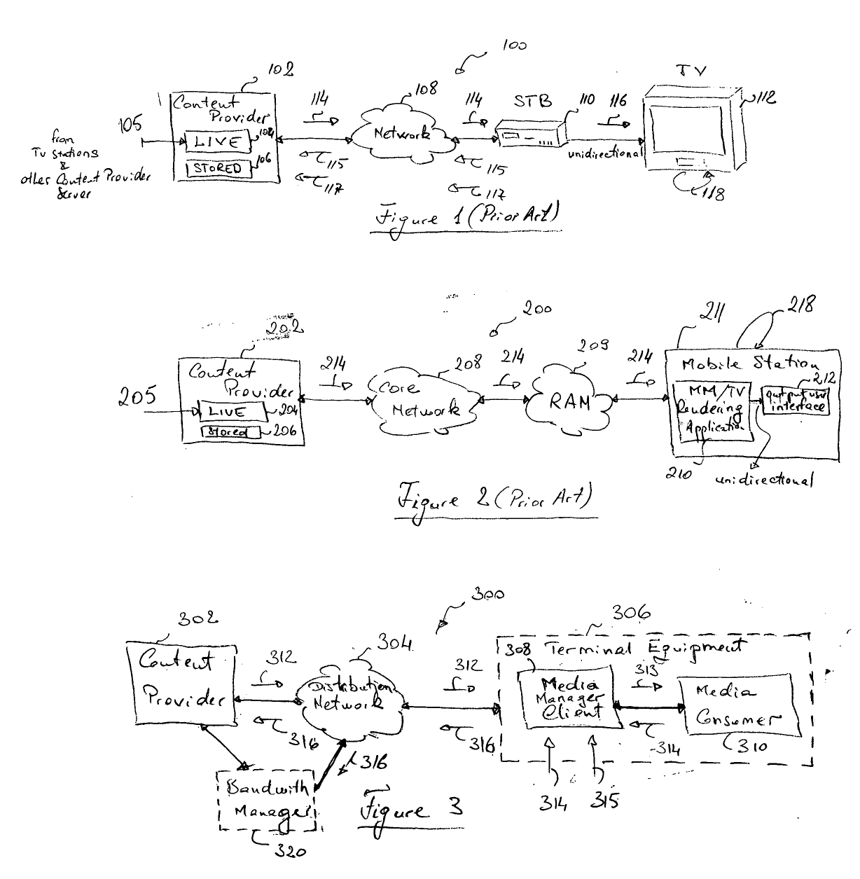

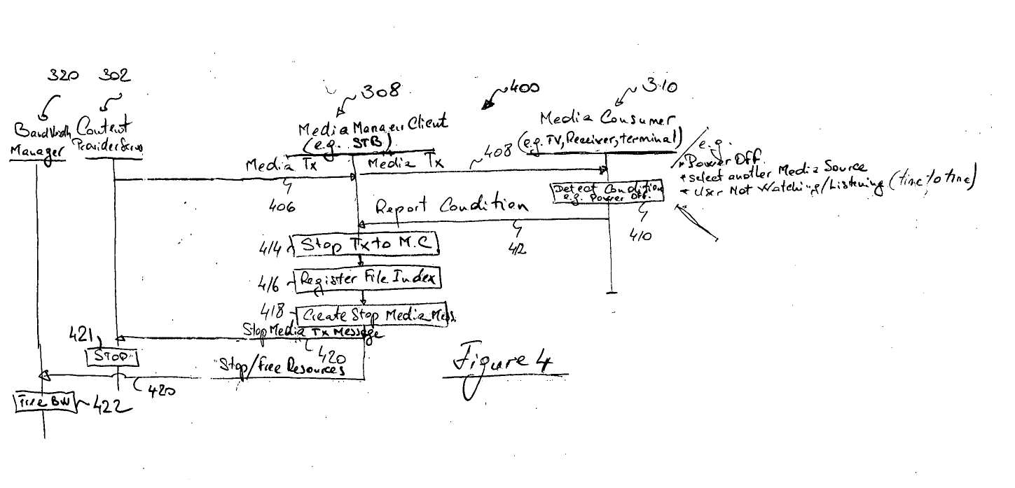

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The above illustrated prior art implementations yield to significant bandwidth and resources utilization in circumstances where a data stream being downloaded towards a user's media consumer (e.g. such as a TV set or a PC screen) is unused because either the media consumer is turned off or because the user has selected a different source of media. For example, in today's implementations, the STBs, or the PC-implemented or MS-implemented multimedia applications continue to download digital multimedia content streams, even in circumstances where these downloads are unused by the viewer or the user.

Accordingly, it should be readily appreciated that in order to overcome the deficiencies and shortcomings of the existing solutions, it would be advantageous to have a method and system for effectively managing multimedia content downloads, including digital television content, to an STB, a Mobile Station (MS), or a Personal Computer (PC), wherein such a downloads are stopped when the viewer or the user does not utilize the downloaded content.

According to the present invention, a media manager client module, such as for example an STB or a PC-implemented or MS-implemented media application receives an indication from a non-user cooperating entity (e.g. a TV set, a display, an Operating System (OS)) that a media stream with a multimedia content being received by the media manager client module from a content provider server is not used. Responsive to the received indication, the media manager client module creates a message for the content provider server to stop transmission of the media stream, and sends the message to the content provider server in order to request the transmission of the media stream to be stopped. Optionally, the message can also be sent or forwarded to a bandwidth manager responsible to free the resources allocated fro the transmission using its allocation table. Thus, with the present invention, as soon as is it detected that a media stream is no longer utilized, the content provider server is requested to stop the transmission, thus freeing up network resources.

Reference is now made to FIG. 3, which is an exemplary high-level network diagram of the preferred embodiment of the invention. Shown in FIG. 3 is a media network 300 that may comprise, for example, a cable television network capable of providing digital television service to viewers, a cellular telecommunications network, the Internet, or any other type of network that supports streaming of digital multimedia content towards terminal equipment. The network 300 thus includes at least one content or service provider server 302 providing media content, such as for example digital television programs, multimedia files of various formats, and the likes. The content provider server 302 is connected to a distribution network 304 used for the transfer, also called herein streaming, of the multimedia content 312 to a terminal equipment 306 of the viewer (also called herein user). The equipment 306 includes a media manager client module 308 responsible for decoding the streamed multimedia content 312 from its encoded format to produce a decoded multimedia signal ready to be played by a media consumer 310, which plays (i.e. plays, and/or runs and/or displays) the decoded media content 313 for the viewer. The media manager client module 308 and the media consumer 310 may have various forms depending on the actual implementation. Table 1 shows several possible implementations of the terminal equipment 306:

TABLE 1

| | Terminal Equipment 306 | |
|---|---|---|
| | Media Manager Client | Media Consumer |
| Implementation | STB | TV set |
| #1 | | or |
| | | Receiver/Amplifier + TV set |
| Implementation | Home Gateway | TV Set |
| #2 | or | or |
| | Remote Service Server | other Display + Speakers |
| Implementation | Mobile Station/PDA's | Mobile Station/PDA's |
| #3 | Multimedia Rendering | User Interface |
| | Application | (eg display, speaker) |
| Implementation | PC-based | PC's |
| #4 | Media Application | User Interface |

The content provider server 302 sends the streamed multimedia content 312 via the distribution network 304 towards the terminal equipment 306. The media manager client 308 of the terminal equipment 306 receives the encoded streamed multimedia content 312, which it decodes to provide a decoded media stream 313 ready to be played by the media consumer 310. The later receives the decoded media stream 313 which it plays for the user's entertainment. At a point in time during the streaming of the multimedia content 312, the media manager client module 308 receives an indication that the media stream being received is no longer used or consumed. Such an indication, may comprise for example a power off signal message 314 received from the media consumer 310, the signal 315 that this media consumer 310 uses a different source of media, an indication 316 that the user currently utilizes a different application on a PC, mobile station, or PDA, or any other type an indication that signals that the multimedia stream 312 is no longer needed. Responsive to the received indication, the media manager client module 308 creates a message 316 for the content provider server 302 to stop transmission of the multimedia stream 312, and sends the request message 316 to the content provider server 302 in order to request the transmission of the multimedia stream 312 to be stopped. Upon receipt of the request message 316, the content provider server 302 stops sending the multimedia stream 312, therefore freeing up the bandwidth reserved over the network 304 for the transmission of that media stream.

In an alternate implementation of the invention, the network 300 may further comprise a bandwidth manager 320 responsible for the management, i.e. the evaluation, allocation, reallocation, and de-allocation of reserved bandwidth for the streaming of media content from the content provider server 302 to terminal equipment. The bandwidth manager 320 is connected to the same distribution network 304, and possibly also directly to the content provider server 302, which transmission bandwidth it manages. According to this alternate implementation, the request message 316 is sent from the terminal equipment 306 to the bandwidth manager 320, instead of, or preferably concomitantly to its transmission to the content provider server 302, so that the bandwidth manager can act to de-allocate and free-up the bandwidth reserved for streaming the multimedia content 312.

Thus, with the present invention, as soon as is it detected that the data stream is no longer utilized, the content provider server 302 is requested to stop the transmission, thus freeing up network resources.

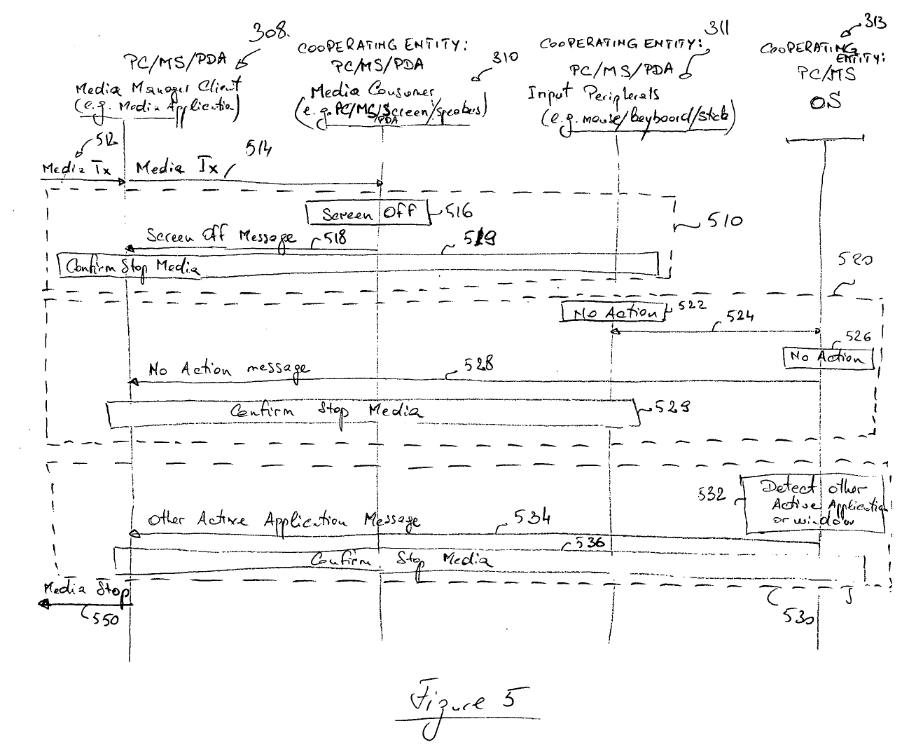

Reference is now made to FIG. 4, which is a nodal operation and signal flow diagram of an exemplary implementation of the preferred embodiment of the invention in a cable network 400. Shown in FIG. 4, is the media manager client module 308, which in the present exemplary implementation comprises an STB functioning to receive from the content provider server 302 encoded digital television signal, such as for example IP-based television streaming according to, for example the MPEG2, or MPEG4 H.264 streamed over RTP (Real-time Transport Protocol) or RTSP (Real-Time Streaming Protocol), and to decode that stream and transform it into a format ready for display on a TV set or a monitor in formats such as for example NTSC (National Television System Committee), PAL (Phase Alternation Line), SECAM (Sequential Couleur avec Memoire), VGA (Video Graphics Array), XVGA (extended Video Graphics Array), or HDTV (High-Definition Television). Also shown in FIG. 4 is the media consumer 310, which in the present implementation comprises a TV set, or a receiver in combination with a TV set, or a TV monitor/display in combination with speakers, and the optional bandwidth manager 320, which may act to manage the bandwidth used for the transmission of a multimedia content 406 from the content provider server 302. When the viewer selects a given channel for viewing, the media manager client module 308 communicates with the content provider server to receive the multimedia content 406, which in the present exemplary scenario comes in the form of an encoded television media transmission stream 406 that contains the multimedia content of the selected channel. Upon receipt of the stream 406, the media manager client module 308 acts to decode the stream 406 and the so-obtained decoded media signal 408 is further sent from the media manager client module 308 to the media consumer 310, where it is played for the viewer's entertainment. However, at a given moment the viewer may power off the media consumer 310 (e.g. the TV set or the receiver), may select another media source (not shown) different than the stream 406 to be played on the media consumer 310, or may otherwise signal the lack of use of the television media transmission stream 406. The later may be detected in various manners, such as for example by regularly displaying a message to the media consumer 310 that requires the viewer to confirm the continual use of the media consumer 310 and/or of the television media transmission stream 406. In action 410, the media consumer 310 detects any one of the above-mentioned conditions relative to the lack of use of the television media transmission stream 406 by the media consumer 310, and in message 412 reports the detected condition to the media manager client module 308. Upon receipt of the message 412 from the media consumer 310, the media manager client 308 stops the transmission 408 of the decoded media signal to the media consumer 310, action 414, optionally registers a file index associated to the exact location within the television media transmission stream 406 where transmission has ceased, action 416, and in action 418 creates a stop media transmission message 420 for sending to the content provider server that transmits the television media transmission stream 406. The media manager client 308 sends to the content provider server 302 the created stop media transmission message 420 in order to request the server to stop the transmission of the media content 406, thus freeing up the transmission resources reserved for the transmission of the media 406. In action 421, the content provider server 302 stops the transmission of the television media transmission stream 406 to the media manager client module 308.

In some implementation wherein the bandwidth manager 320 is responsible for managing the bandwidth resources on behalf of the content provider server 302, the media manager client 308 may be configured to also send the stop media transmission message 420 to the bandwidth manager 320, so that the later can act to free up the bandwidth resources reserved for the transmission of the television media transmission stream 406, action 422. In such a variant, the message 420 may be identical to the one described above, or may include specific commands destined to the bandwidth manager 320 for freeing up the bandwidth resources. Additionally, the bandwidth manager 320 may be part of the content provider server 302, or may be implemented as a separate entity.

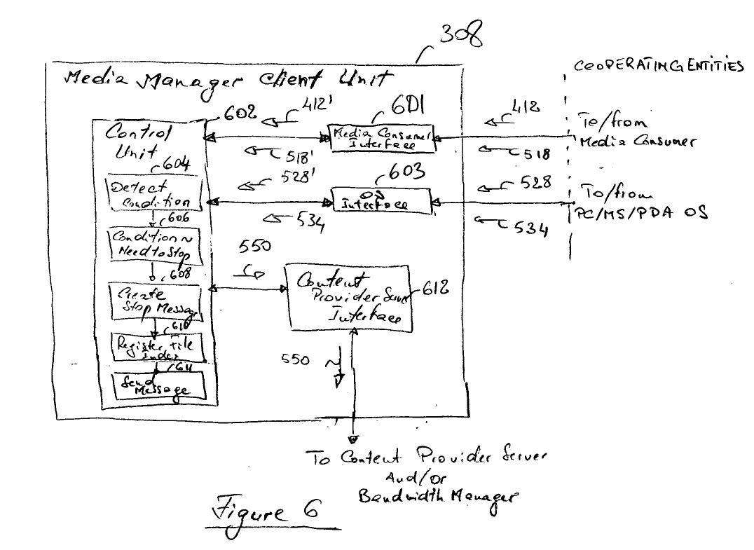

Reference is now made to FIG. 5, which is a nodal operation and signal flow diagram illustrative of several other exemplary implementations of the preferred embodiment of the invention. Shown in FIG. 5 are the exemplary implementations 510, 520, and 530 of the preferred embodiment of the invention. In the various implementations 510, 520, and 530 of FIG. 5, it can be seen that the media manager client 308 can receive various types of indications (e.g. 518, 528, and 534) from various types of entities, i.e. the media consumer 310, the input peripherals 311, and the OS 313, all of which are herein designated as non-user cooperating entities with respect to the media manager client 308, in order to indicate the lack of use of the multimedia content.

For example, the exemplary implementation 510 uses a media manager client 308 implemented in a PC, a mobile station, or a PDA, which may have the form of a media application module running in that PC, mobile station, or PDA, or of a partly software, partly hardware module. The exemplary implementation 510 further uses a media consumer 310 which has the form of an output user interface of the PC, mobile station, or PDA that includes display and speakers. Finally, the implementation 510 uses input peripherals 311 of that PC, mobile station, or PDA (e.g. mouse, keyboard, control stick).

In the exemplary implementation 510, first, the media manager client 308 is receiving multimedia content in the form of an encoded multimedia stream 512 from a content provider server. Upon receipt of the multimedia stream 512, the media manager client 308 decodes the incoming multimedia stream 512 and provides to the media consumer 310 a decoded media stream 514 ready to be played by the media consumer 310. Typically, the media stream 514 may comprise still or moving images (e.g. video), and a sound signal. In action 516, the media consumer 310 is turned off, such as for example when the user turns off the display of his PC, mobile station, or PDA (in the later case of the mobile station and PDA, it is assumed that the turning off of the media consumer 310, i.e. for example of the display, does not include entirely turning off the mobile station and PDA). As a consequence, in action 518, the media consumer 310 sends a display off message to the media manager client 308 to inform the later that the content of the multimedia stream 512 is no longer played, thus no longer used, since for example the display has been turned off. The media manager client 308 may further perform optional action 519, wherein it confirms with the user that it should stop the multimedia stream 512. Such an action may be performed in combination with the media consumer 310 and the input peripherals 311, for example by powering on again the display part of the media consumer 310 in order to prompt the user whether or not the media transmission should be stopped, and to record the user's input, e.g. a “yes” or “no” answer using the peripherals 311. In the event action 519 is not performed, or when action 519 is performed and the user confirms the media transmission should be stopped, in action 550, the media manager client 308 sends to the content provider server and/or to the bandwidth manager a media stop request message in order to terminate the multimedia stream 512 and to free up the bandwidth resources reserved for that transmission. As a consequence, the multimedia stream 512 from the content provider server to the media manager client 308 stops, and the resources used for that transmission are freed (actions shown in FIG. 4).

Reference is now further made to the exemplary implementation 520 of FIG. 5, which involves the media manager client 308, the media consumer 310, the input peripherals 311 of the PC, mobile station, or PDA (e.g. mouse, keyboard, control stick), all of which have been described hereinbefore in relation to the implementation 510, and further the Operating System platform (OS) 313 of the PC, MS, or PDA. In the exemplary implementation 520, first, the media manager client 308 is receiving the multimedia content in the form of a multimedia stream 512 from a content provider server. Upon receipt of the multimedia stream 512, the media manager client 308 decodes the incoming encoded stream 512 and provides to the media consumer 310 a decoded media stream 514 ready to be played by the media consumer 310. In action 522, the input peripherals 311 sense no user action for a predetermined period of time, and this condition is further sensed by the OS 313, which may trigger activation of a screen saver on, or the turn off the display of the consumer 310. For example, the OS 313 may be in constant communication 524 with the peripherals 311, and can sense the lack of user action and the activation of the screen saver application, or simply the turn off of the display by the user, action 526. As a consequence, in action 528, the OS 313 communicates with the media manager client 308 to inform the later that the multimedia stream 512 is no longer played, since the display of the media consumer 310 no longer shows the media content being received. The media manager client 308 may further perform optional action 529, wherein it confirms that it should stop the media transmission toward the media consumer 310 as described hereinbefore in relation to action 519. In the event the action 529 is not performed, or when action 519 is performed and the user confirms the media transmission should be stopped, in action 550 the media manager client 308 sends to the content provider server and/or to the bandwidth manager a media stop request message in order to terminate the multimedia stream 512 and to free-up the bandwidth resources reserved for that transmission. As a consequence, the multimedia stream 512 from the content provider to the media manager client 308 stops, and the resources used for that transmission are freed.

In the exemplary implementation 530, first, the media manager client 308 is receiving the multimedia stream 512 from the content provider server, and decodes the incoming multimedia stream 512 to provide to the media consumer 310 a decoded media stream 514 ready to be played. In action 532, the OS 313 senses that another application than the media application that renders the media stream becomes active (i.e. is actively utilized by the user). In action 534 the OS 313 sends a message 534 to the media manager client 308 to inform the later that the other application became active, which also implies that the media application is no longer the active application on the PC, mobile station or PDA. The media manager client 308 receives the message 534 and concludes that the media application is no longer the active application and that the multimedia stream 512 is useless, because no longer utilized by the media consumer 310. The media manager client 308 may further perform optional action 536, wherein it asks the user for confirmation that it should stop the multimedia stream 512 toward the media consumer 310. Such an action may be performed in combination with the media consumer 310 and the input peripherals 311, for example by prompting the user whether or not the transmission of the multimedia stream 512 should be stopped, and recording the user's input, e.g. a “yes” or “no” answer using the peripherals 311. In the event the action 536 is not performed, or when action 536 is performed and the user confirms the multimedia stream should be stopped, in action 550, the media manager client 308 sends to the content provider server and/or to the bandwidth manager a media stop request message in order to terminate the transmission of the multimedia stream 512 and to free up the bandwidth resources reserved for that transmission. As a consequence, the transmission of the multimedia stream 512 from the content provider to the media manager client 308 stops, and the resources used for that transmission are freed.

Reference is now made to FIG. 6, which is a high level block diagram of an exemplary implementation of the preferred embodiment of the invention in the media manager client unit 308 that may be implemented in a PC, mobile station or PDA. Shown in FIG. 6, is the media manager client unit 308 comprising a media consumer interface 601 which insures communication of the media manager client unit 308 with a media consumer, such as for example a display and pointing devices. Further shown is an OS interface 603 that insures communication of the media manager client 308 with the OS of the PC, mobile station, or PDA depending upon the actual implementation, a content provider server interface 612 that insures communication of the media manager client 308 with content provider servers, and a control unit 602, which is responsible to process messages and commands in relation with various applications run on the PC, mobile station, and PDA. The functions of the control unit 602 include processing and interpreting messages received from the media consumer and the OS, in order to issue control messages destined for the content provider server and/or the bandwidth manager. The interfaces 601, 603, and 612 are connected to the control unit 602 via suitable communication means, depending upon the particular implementation. According to the present invention, the media manager client unit 308 receives from the media consumer 310 messages 412 or 518, as described hereinbefore in relation to FIGS. 4 and 5, which purpose is to inform the media manager client unit 308 of a condition associated with the media consumer 310 wherein the later does no longer uses the media stream sent from the media manager client. Messages 412 or 518 are received by the media consumer interface 601 which may reformat them into a format 412′ and 518′ respectively, proper for processing by the control unit 602. The media consumer interface 601 sends the messages 412′ and 518′ to the control unit 602.

Likewise, the media manager client unit 308 may also receive from the OS 313 messages 528 and 534 to inform the media manager client unit 308 that the media application responsible for rendering the media stream from the content provider server is no longer used, as it is described herein before in relation with the exemplary implementations 520 and 530 of FIG. 5. Messages 528 and 534 are received by the OS interface 603, and possibly reformatted into messages 528′ and 534′ respectively, with a format proper for processing by the control unit 602. Then, the OS interface 603 sends the messages 412′ and 518′ to the control unit 602.

Whenever the control unit 602 receives any one of the messages 412′, 518′, 528′, or 534′, it detects the condition associated with that message, i.e. that the media stream is no longer used by the media consumer, action 604, and in action 606, it concludes that the media stream needs to be stopped. For this purpose, in action 608, the control unit 602 creates a media stop message 550 to be sent to the content provider server in order to request the stop of the media stream. In action 610, the control unit 602 registers the file index of the media stream, i.e. the exact location within the media stream file where the transmission has been stopped, which may be later used for resuming the transmission of the media stream file at the file index location where it has been interrupted. In action 611, the control unit 602 sends the media stop request message 550, which is sent via the content provider server interface 612 the content provider server and/or to the bandwidth manager.

Based on the media stop request message 550, the content provider server acts to stop the transmission of the media stream thus freeing up resources in the network. As mentioned, in an alternate variant of the invention, it is the bandwidth manager that acts to free-up the bandwidth resources allocated fro the transmission of the media stream.

The present invention provides a simple yet effective method and system for insuring that bandwidth of a multimedia network is not unduly wasted when a viewer stops watching a given program. The present invention is useful in various network implementations, such as for example but not limited to, for digital television where unicast technology is used for sending digital TV content to a viewer, for IPTV, or for any type of multimedia file streaming to a multimedia application of a PC. Mobile station or PDA.

Based upon the foregoing, it should now be apparent to those of ordinary skills in the art that the present invention provides an advantageous solution, which insures that bandwidth is optimally used, and released when a media consumer stops using a given media content. Although the system and method of the present invention have been described in particular reference to certain exemplary scenarios, it should be realized upon reference hereto that the innovative teachings contained herein are not necessarily limited thereto and may be implemented advantageously with various applicable multimedia streaming standards. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth herein below.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for controlling communications, the method comprising the steps of:
a. receiving at a media manager client from a cooperating entity an indication that a multimedia content being received by the media manager client from a content provider server is not used;
b. responsive to a receipt of the indication from a cooperating entity, creating a message for requesting an end of a transmission of the multimedia content; and
c. sending the message to request the end of the transmission of the multimedia content.

2. The method claimed in claim 1, wherein the cooperating entity comprises a media consumer connected to the media manager client, the media consumer, at least prior to step b. receiving from the media manager client a decoded multimedia content intended to be played by the media consumer.

3. The method claimed in claim 2, wherein the media manager client comprises a television Set-Top Box (STB), and the media consumer comprises a TV set.

4. The method claimed in claim 3, further comprising the step of:
d. recording a file index of the multimedia content indicative of a location where the transmission of the multimedia content is stopped.

5. The method claimed in claim 2, wherein the media manager client comprises a multimedia application run on one of a computer, a mobile station, and a Personal Digital Assistant (PDA), and the media consumer comprises a display.

6. The method claimed in claim 1, wherein the media manager client comprises a multimedia application run on one of a computer, a mobile station, and a Personal Digital Assistant (PDA), and the cooperating entity comprises an Operating System (OS) of one of the computer, mobile station and PDA.

7. The method claimed in claim 6, wherein the indication that the multimedia content being received by the media manager client is not used is issued by the OS upon detection of another active application different than the multimedia application.

8. The method claimed in claim 6, wherein the indication that the multimedia content being received by the media manager client is not used is issued by the OS upon detection of a period of no action of a user of the multimedia application.

9. A media manager client unit comprising:
an interface which is adapted to receive from a cooperating entity an indication that a multimedia content being received by the media manager client from a content provider server is not used; and
a control unit receiving the indication from the interface, the control unit being configured to create a message for requesting an end of a transmission of the multimedia content responsive to a receipt of the indication, and to send the message to request the end of the transmission of the multimedia content.

10. The media manager client unit claimed in claim 9, wherein the cooperating entity comprises a media consumer connected to the media manager client unit, whereby the media consumer receives from the media manager client unit a decoded multimedia content intended to be played by the media consumer.

11. The media manager client unit claimed in claim 10, wherein the media manager client comprises a television Set-Top Box (STB).

12. The media manager client unit claimed in claim 11, wherein the control unit is configured to record a file index of the multimedia content indicative of a location where the transmission of the multimedia content is stopped.

13. The media manager client unit claimed in claim 10, wherein the media manager client unit comprises a multimedia application run on one of a computer, a mobile station, and a Personal Digital Assistant (PDA).

14. The media manager client unit claimed in claim 9, wherein the media manager client unit comprises a multimedia application run on one of a computer, a mobile station, and a Personal Digital Assistant (PDA), and the cooperating entity comprises an Operating System (OS) of one of the computer, mobile station and PDA.

15. The media manager client unit claimed in claim 14, wherein the indication that the multimedia content being received by the media manager client unit is not used is received from the OS upon detection of another active application different than the multimedia application.

16. The media manager client unit claimed in claim 14, wherein the indication that the multimedia content being received by the media manager client is not used is received from the OS upon detection of a period of no action of a user of the multimedia application.

17. A multimedia distribution system comprising:
a content provider server;
a media manager client connected to the content provider server and receiving from the content provider server a multimedia content; and
a cooperating entity connected to the media manager client, the cooperating entity sending to the media manager client an indication that the multimedia content being received by the media manager client from the content provider server is not used;
the media manager client, upon receipt of the indication, acting to create a message for requesting an end of a transmission of the multimedia content and further acting to send the message to the content provider to request the end of the transmission of the multimedia content.

18. The multimedia distribution system claimed in claim 17, further comprising:
a media consumer connected to the media manager client and receiving from the media manager client a decoded multimedia content.

19. The multimedia distribution system claimed in claim 18, wherein the media consumer is the cooperating entity.

20. The multimedia distribution system claimed in claim 17, further comprising:
a bandwidth manager, wherein the media manager client sends the message also the bandwidth manager, which upon receipt of the message acts to free up bandwidth resources reserved for the transmission of the multimedia content.

21. The multimedia distribution system claimed in claim 18, wherein the media manager client comprises a television Set-Top Box (STB), and the media consumer comprises a TV set.

22. The multimedia distribution system claimed in claim 18, wherein the media manager client comprises a multimedia application run on one of a computer, a mobile station, and a Personal Digital Assistant (PDA), and the media consumer comprises a display.

23. The multimedia distribution system claimed in claim 18, wherein the media manager client comprises a multimedia application run on one of a computer, a mobile station, and a Personal Digital Assistant (PDA), and the cooperating entity comprises an Operating System (OS) of one of the computer, mobile station and PDA.

24. The multimedia distribution system claimed in claim 23, wherein the indication that the multimedia content being received by the media manager client is not used is issued by the OS upon detection of another active application different than the multimedia application.

25. The multimedia distribution system claimed in claim 23, wherein the indication that the multimedia content being received by the media manager client is not used is issued by the OS upon detection of a period of no action of a user of the multimedia application.
